(19) United States
(12) Patent Application Publication
(10) Pub. No.: US 2017/0116127 A1
(43) Pub. Date: Apr. 27, 2017

(54) FILE SYSTEM ADAPTIVE READ AHEAD

(71) Applicant: Vormetric, Inc., San Jose, CA (US)

(72) Inventor: Ellard Roush, San Jose, CA (US)

(21) Appl. No.: 14/920,130

(22) Filed: Oct. 22, 2015

(51) Int. Cl. G06F 12/08

(52) U.S. Cl. CPC G06F 12/0862; G06F 12/0882; G06F 2212/1024; G06F 2212/602

(57) ABSTRACT

A processor-based method for adaptive read ahead is provided. The method includes satisfying a read request with sequential reads from a page cache in a first memory and read ahead from a storage memory to the page cache in the first memory, and adjusting upward an amount of data to be read by a cycle of the read ahead, responsive to a determination that a desired page of data for the read request is not in the page cache.

### BACKGROUND

In many storage systems, file system software supports a feature called Read Ahead. Most file system read access patterns are sequential. Numerous empirical studies over the past three decades have shown that almost all file accesses are sequential (e.g., well over 90% of all read accesses). Special code, called Read Ahead, takes advantage of this read access pattern. The file system software keeps track of where in a file the client thread last executed a read operation. When the thread next executes a read, the file system software checks whether the latest read sequentially follows the previous read. If yes, the file system knows that the thread is performing sequential reads. Reading data from disk or other storage memory is a very slow operation compared to activity happening in main memory. The file system automatically reads in data that sequentially follows the data that has just been requested. In some current file systems the amount of additional data that will be read is a fixed amount. The next time the client thread executes a file read operation, the file system can satisfy the read operation using data that is either already in memory or is already on its way to main memory, which significantly improves performance. Whenever the file system detects that the read request is not sequential, the file system either stops reading additional information or reduces the amount of data to a small amount. The fundamental problem with all current forms of Read Ahead is that the current technology does not recognize whether the Read Ahead feature is effective.

Prior solutions use a fixed maximum value for the amount of data to read ahead. It is not possible to have one single best value for all platforms and workloads. One approach attempts to guess or try a few values empirically and choose a value that seems like a reasonable compromise for the range of platforms that they plan to support with their file system. If a large value that is appropriate for a system is chosen, the read ahead will consume too much memory on smaller systems, which can cause the system to fail. Thus, a value for read ahead that is too small for achieving the best performance for a system is typically chosen to avoid any failure. The old forms of read ahead achieved useful improvements in read performance, but much less than what was possible. File system read operations tend to be the most important file system operation impacting file system performance and achieving optimal file system read performance is essential for maximizing file system performance.

It is within this context that the embodiments arise.

### SUMMARY

In some embodiments, a processor-based method for adaptive read ahead is provided. The method includes satisfying a read request with sequential reads from a page cache in a first memory and read ahead from a storage memory to the page cache in the first memory, and adjusting upward an amount of data to be read by a cycle of the read ahead, responsive to a determination that a desired page of data for the read request is not in the page cache.

In some embodiments, a tangible, non-transitory, computer-readable media having instructions thereupon which, when executed by a processor, cause the processor to perform a method is provided. The method includes performing read ahead cycles, with an amount of data read from a storage memory to a page cache in a first memory in each of the read ahead cycles, to satisfy a read request having sequential reads from the page cache. The method includes determining a status of a desired page of data for the read request, and increasing the amount of data to be read in at least one subsequent read ahead cycle, as a result of determining the desired page is not in the page cache at a time of servicing a sequential read of the desired page.

In some embodiments, adaptive read ahead system is provided. The system includes at least one processor and an adaptive read ahead module in cooperation with the at least one processor. The adaptive read ahead module has a data read ahead adjuster and a read ahead director. The read ahead director is configured to perform read ahead cycles, each read ahead cycle reading an amount of data from a storage memory to a page cache in a first memory, responsive to a read request having sequential reads from the page cache. The data read ahead adjuster is configured to determine whether a desired page for the read request is in the page cache and the data read ahead adjuster is configured to increase the amount of data for one or more read ahead cycles, responsive to determining that the desired page is not in the page cache.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram of a storage system with main memory and storage memory, and an adaptive read ahead module in accordance with an embodiment of the present disclosure.

FIG. 2 is a conceptual diagram of the data read ahead adjuster of FIG. 1, illustrating how the data read ahead adjuster sets a value for the amount of data to read ahead.

FIG. 3 is a flow diagram for a method of operating the adaptive read ahead module of FIG. 1.

FIG. 4 is an illustration showing an exemplary computing device which may implement the embodiments described herein.

### DETAILED DESCRIPTION

An adaptive read ahead system, described herein, determines whether read ahead is bringing in enough data to main memory, prior to data being read out of the main memory by sequential reads, to prevent stalling or excess delays. The system adjusts the amount of data to read ahead, in read ahead cycles, based on the whereabouts of the desired page of data that follows the current page being read out of main memory. If the desired page is found in a page cache in main memory, the amount of data to be read ahead in read ahead cycles is kept constant. If the desired page is not yet fully in the page cache and the read ahead value has not reached a maximum value, the amount of data to be read ahead in read ahead cycles is increased. By so adjusting the amount of data to read ahead, the adaptive read ahead system improves efficiency of the storage system and decreases latency of sequential reads.

If the desired page is neither in the page cache nor in transit, a read ahead cycle is triggered. Waiting for the sequential read to reach a point where there is no data in the page cache is undesirable, because that results in a stall. The read must wait a long time for the system to bring data from storage memory to the page cache. The present design attempts to avoid this problem. The read ahead value normally brings in more than one page. Instead of triggering a read ahead when the sequential read consumes all of the data in this set of pages being brought in by read ahead, the system triggers the next read ahead when the sequential read consumes only a small part of the pages that were or will be brought in by recent read ahead operations. Thus, the system reads in the next batch of pages, while reads consume pages brought into main memory by earlier read ahead operations.

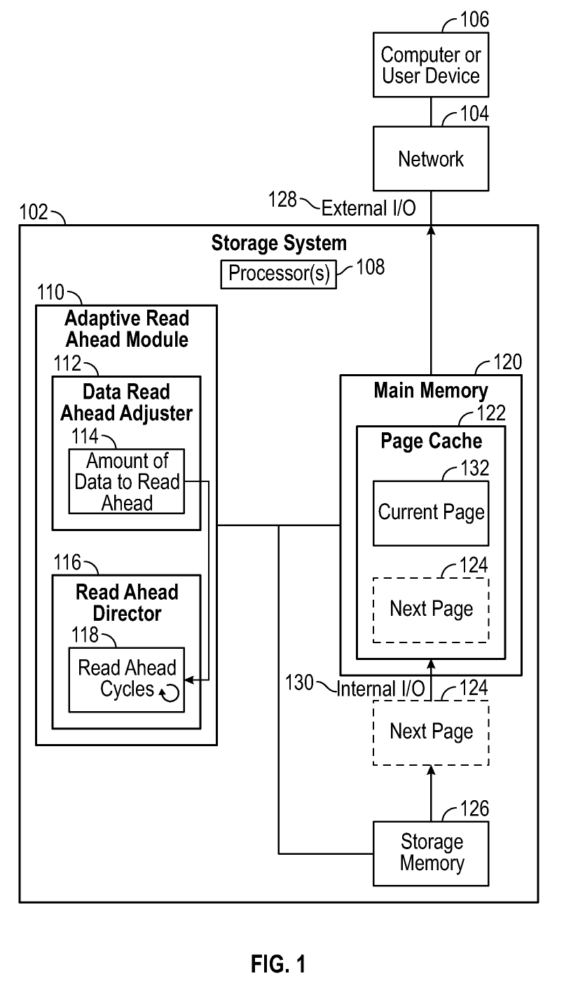

FIG. 1 is a system diagram of a storage system 102 with main memory 120 and storage memory 126, and an adaptive read ahead module 110 in accordance with an embodiment of the present disclosure. Storage memory 126 is the memory from which the data read ahead operations source the data that is read into the main memory 120, and could include various types of persistent storage, whether or not organized into storage tiers, etc. Main memory 120 is the memory from which external I/O (input/output) 128 is serviced. The adaptive read ahead module can be implemented in software executing on one or more processors 108, firmware, hardware, or various combinations thereof. The adaptive read ahead module 110 cooperates with main memory 120 and storage memory 126 of a storage system 102, which could be all local to each other, or networked, distributed, or implemented in a virtual computing environment with physical computing resources, etc. In the scenario depicted in FIG. 1, a computer or user device 106 is reading a file from the storage system 102, using sequential reads and external I/O (input/output) 128 via a network 104. In further scenarios, a computer or user device 106 could be accessing the storage system 102 through a bus, or could be integrated with the storage system 102 or otherwise connected to the storage system 102. As the data of the file is read out from the main memory 120 in service of the external I/O 128, the adaptive read ahead module 110 uses read ahead and internal I/O 130, to move pages from storage memory 126 to a page cache 122 in main memory 120 of the storage system 102.

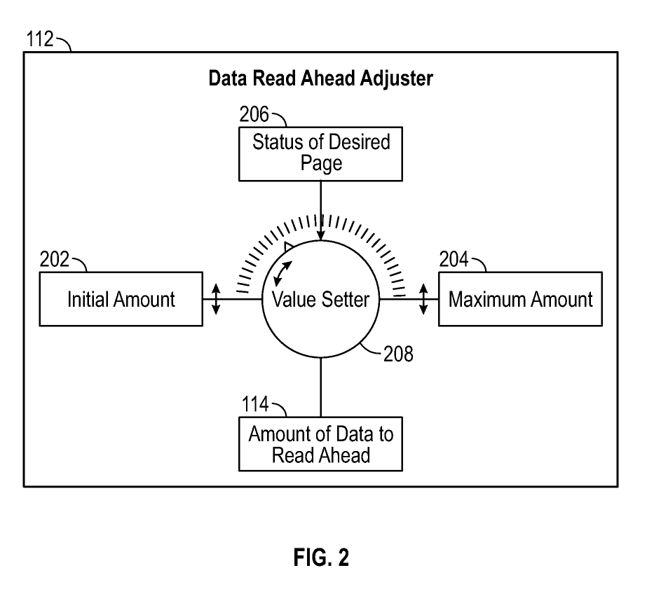

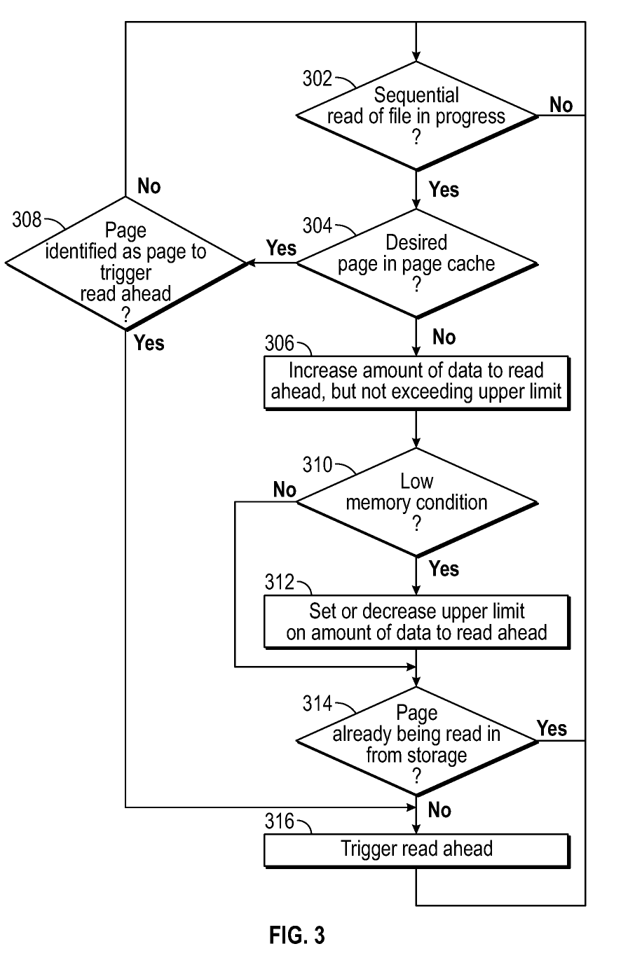

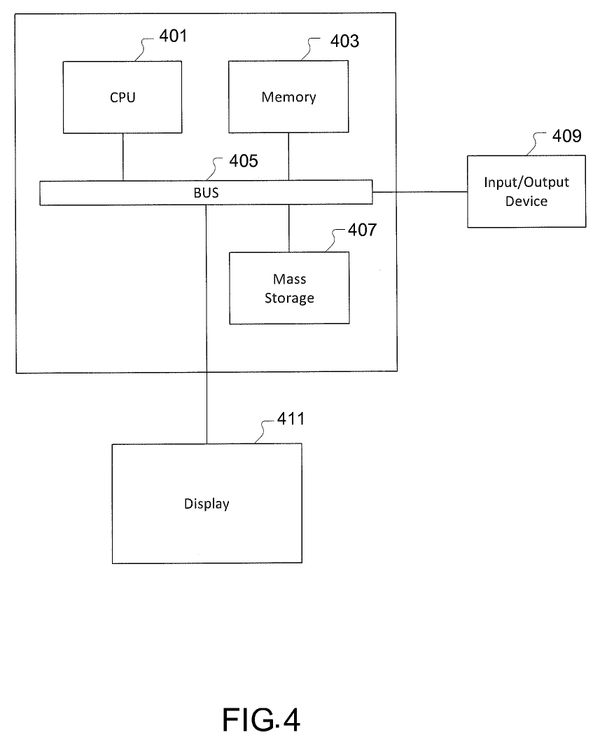

Thus far in the description, the storage system 102 with read ahead has some similarities with known read ahead systems. However, the present adaptive read ahead module 110 uses a process and mechanism for an adjustable amount of data to read ahead 114, which differs from known read ahead systems. The adaptive read ahead module 110, in some embodiments, has a data read ahead adjuster 112 and a read ahead director 116. The read ahead director 116 performs read ahead cycles 118, each moving a next page 124 (depicted in dashed outline) from storage memory 126 to the page cache 124 in main memory 120. Status of desired pages (e.g., data that the storage system 102 seeks to read out for external I/O 128 in order to service a read request) is monitored by the data read ahead adjuster 112, which adjusts the amount of data to read ahead 114 under various conditions. The data read ahead adjuster 112 communicates the amount of data to read ahead 114 to the read ahead director 116, which then uses this value of the amount of data to read ahead 114 in the read ahead cycles 118. In some embodiments, the data read ahead adjuster 112 and read ahead director 116 are integrated. In some embodiments, the data read ahead adjuster 112 augments a standard read ahead module. And, in some embodiments the data read ahead adjuster 112 and read ahead director 116 replace a standard read ahead module. Operations of various embodiments of the read ahead director 116 and the data read ahead adjuster 112 are further described below with reference to FIG. 2 and the flow diagrams of FIGS. 3 and 4.

FIG. 2 is a conceptual diagram of the data read ahead adjuster of FIG. 1, illustrating how the data read ahead adjuster sets a value for the amount of data to read ahead. The data read ahead adjuster 112 monitors the status of a desired page 206, for example by communicating with the read ahead director 116, the storage memory 126 and/or the main memory 120. When the storage system 102 is servicing a read request, the desired page for the read request could be a current page 132 in the page cache 122, if the read ahead cycles 118 are keeping up with the sequential reads, or the desired page for the read request could be the next page 124 coming from the storage memory 126 to the page cache 122 in a read ahead cycle 118. This presumes sequential data reads, e.g., of a file, are being performed by the storage system 102, e.g., on behalf of the computer or user device 106 (refer back to FIG. 1). The data read ahead adjuster 112 varies the value setter 208 between an initial amount 202 and a maximum amount 204, to set the amount of data to read ahead 114 based on the status of the desired page 206. It should be appreciated that the mechanisms depicted in FIG. 2, and related processes, are implemented in software, firmware and/or hardware, and would not actually have a physical, variable adjustment knob such as conceptually depicted herein. The drawing symbolizes setting a value of a parameter.

Obtaining the status of a desired page 206, the data read ahead adjuster 112 determines whether the desired page is entirely present in the page cache 122 (e.g., as a current page 132), is in the process of being read from the storage memory 126 to the page cache 122 in the main memory 120 (e.g., as the next page 124), or is not yet in transit nor present in the page cache 122 (e.g., when there is not a read ahead cycle 118 transferring the next page 124 to the page cache 122). Based on these possibilities, the data read ahead adjuster 112 sets the value of the amount of data to read ahead 114. While the current read request is being serviced out of the page cache 122 in main memory 120 (e.g., reading out to the network 104 and/or the computer or user device 106), if the desired page is complete in the page cache 122 of main memory 120 (i.e., the desired page is the current page 132 in the page cache 122), the data read ahead adjuster 112 keeps the amount of data to read ahead 114 the same for the next read ahead cycle as in the previous read ahead cycle. In conceptual terms, the value setter 208 is kept at a constant setting for the amount of data to read ahead 114. This is because the read ahead cycles 118 are determined to be keeping up with the sequential reads of current pages 132 from the page cache 122.

While the current read request is being serviced out of the page cache 122, if the desired page is incomplete in the page cache 122, or absent from the page cache 122, but is in transit from the storage memory 126 to the page cache 122 (e.g., is being read using internal I/O 130 as the next page 124 from the storage memory 126 to the page cache 122, but is not yet completely in the page cache 122), the data read ahead adjuster 122 increases the amount of data to read ahead 114 for the next read ahead cycle as compared to the previous read ahead cycle. In conceptual terms, the value setter 208 for the amount of data to read ahead 114 is moved or adjusted upward. This is because the read ahead cycles 118 are determined to be not quite keeping up with the sequential reads of current pages 132 from the page cache 122, warranting the increase in the amount of data to read ahead 114. The new value of the amount of data to read ahead 114 may be kept for one or more subsequent read ahead cycles 118.

While the current read request is being serviced and the sequential read has consumed a specified amount of the pages that were or are about to be brought into the main memory 120 by the recent read ahead operations, if a desired page is not in the page cache 122 and is also not in transit from the storage memory 126 to the page cache 122, the data read ahead adjuster 112 cooperates with the read ahead director 116 to trigger a read ahead cycle 118. This is so as to get the desired page, which will become the next page 124, moving towards and into the page cache 122, for an upcoming read of a current page 132. Upon arrival in the page cache 122, the next page 124 may become the current page 132 for a read request (assuming the sequential reads are continued). In various embodiments, the amount of data to read ahead 114 could be left as is, or adjusted upward.

In some embodiments, the value setter 208 is constrained by an initial amount 202 and a maximum amount 204. These could be default values, predetermined or system-dependent. Or one or both of these could be variables. In one embodiment, the maximum amount 204 is set initially, but decreased if a low memory condition is detected in the main memory 120. In other words, the amount of data to read ahead 114 could be set anywhere between the initial amount 202 and the maximum amount 204, which could be adjusted downward in event of a low memory condition.

With reference to FIGS. 1 and 2, further aspects of various embodiments are described below. Some embodiments operate in a Linux environment. When performing I/O in Linux, the software holds the page struct lock for each page of file data being processed. The software releases the page struct lock when the I/O completes. One embodiment of the Adaptive Read Ahead software uses the Linux trylock_page( ) function to determine whether I/O is in progress. This only indicates that either a read or a write is under way. However, almost all sequential I/O is either all reads or writes for extended periods. So, if the system is currently processing a read request, the I/O is highly likely to be another read request, and more specifically a read ahead is likely to be underway. The Adaptive Read Ahead software treats this fact as an indication that earlier read aheads did not bring in enough data in order to get the data into main memory prior to being requested by a client thread. The Adaptive Read Ahead software now increases the amount of data that will be brought into main memory by subsequent read aheads.

Read ahead is a heuristic. In other words, the read ahead operation does not have to be correct 100% of the time. Various algorithms can be wrong without causing any failures. In some embodiments, an algorithm is useful as long as it is correct most of the time. The Adaptive Read Ahead is correct the vast majority of the time and performance tests show a large performance improvement.

In some embodiments, the above test plays an important role. The adaptive read ahead can reliably determine whether read ahead is bringing data into memory in time to avoid costly waits and adjust the amount of data to read ahead accordingly. This dynamically adjusts the amount of read ahead. The appropriate amount of data to read ahead varies across hardware platforms. Many hardware factors may affect the read ahead setting. These may include, but are not limited to: CPU processing speed, main memory access speed, and storage subsystem speed. The appropriate amount of data to read ahead may also vary depending upon the system load. Various embodiments dynamically adjust to the needs of the system. The above acts as a feedback mechanism that decreases read latency in a storage system. This improves system performance (especially, read performance in a storage system) by eliminating or significantly reducing the amount of time a client thread waits for data delivered by a file system read operation (i.e., improves read latency). Furthermore, embodiments can avoid being overly aggressive with read ahead, and thus avoid consuming main memory that is not required for good performance. The adaptive read ahead mechanism starts with a small value for the amount of data to read ahead, and rapidly grows until a good setting is determined for the amount of data to read ahead. The adaptive read ahead mechanism thus avoids using a setting that is either too high or too low for the amount of data to read ahead.

Similar to known systems, some embodiments of the adaptive read ahead module 110 check for sequential versus non-sequential reads, and if the system detects that the read request is not sequential, the system stops the read ahead cycles 118 or decreases the amount of data to read ahead 114. The file system adaptive read ahead mechanism automatically adjusts the amount of data to read ahead 114 in order to eliminate, or at least minimize, the amount of time that a client thread must wait for the data delivered by a file system read request. The file system adaptive read ahead mechanism significantly improves file system performance by eliminating, or at least minimizing, the amount of waiting involved in file system read operation. Note that file system read performance is a very important factor in overall file system performance. The file system adaptive read ahead mechanism eliminates the need for extensive empirical tests that are often used to choose a value for the amount of data to read ahead. An important aspect of the file system adaptive read ahead is that it uses information about whether read ahead has succeeded in bringing data into memory prior to the client thread requesting the data. This information is important for correctly dynamically adjusting the amount of data to bring into main memory via read ahead. This mechanism or process can be used in most modern operating systems.

FIG. 3 is a flow diagram for a method of operating the adaptive read ahead module of FIG. 1. The flow diagram shows an example of one cycle of read ahead. Read ahead cycles are iterative, and continue for as long as a sequential read of a file is occurring. In a decision action 302, it is determined whether there is a sequential read of a file in progress. If the answer is no there is not a sequential read of a file in progress, for example if there is either no read occurring at the time of inquiry or there is a read of a file, but it is a random access of a file, then flow branches back to the decision action 302, or continues elsewhere. If the answer is yes, there is a sequential read of a file in progress, flow proceeds to the decision action 304.

In the decision action 304, it is determined whether a desired page is in the page cache. If the answer is yes, the desired page is in the page cache, flow proceeds to the decision action 308. If the action is no, the desired page is not in the page cache, flow proceeds to the action 306. In the decision action 308, is determined whether there is a page identified as the page to trigger a read ahead. If the answer in the decision action 308 is no, there is not yet a page identified as the page to trigger a read ahead, flow branches back to the decision action 302, to see if there is a sequential read of a file in progress. If the answer in the decision action 308 is yes, there is a page identified as the page to trigger a read ahead, then flow proceeds to the action 316, to trigger a read ahead.

In the action 306, arrived at because the desired page is not in the page cache, the amount of data to read ahead is increased, but not so as to exceed an upper limit Flow proceeds to the decision action 310 where it is determined whether there is a low memory condition. If there is not a low memory condition, flow proceeds to the decision action 314. If there is a low memory condition, flow proceeds to the action 312. In the action 312, the upper limit on the amount of data to read ahead is set at a specified value, or decreased. The resultant specified or decreased value should be appropriate to the low memory condition.

Flow proceeds to the decision action 314 where is determined whether there is a page already being read in from storage. In some versions, this is the same desired page referred to in the decision action 304. In other versions, this is a different (e.g., newer or more recent) desired page. If the answer in the decision action 314 is yes, the page is already being read in from storage, flow branches back to the decision action 302, to see whether there is a sequential read of a file in progress. If the answer in the decision action 314 is no, the page is not already being read in from storage, flow proceeds to the action 316, to trigger a read ahead. After the action 316, flow proceeds back to the decision action 302, to determine whether a sequential read of a file is in progress.

It should be appreciated that the methods described herein may be performed with a digital processing system, such as a conventional, general-purpose computer system. Special purpose computers, which are designed or programmed to perform only one function may be used in the alternative. FIG. 4 is an illustration showing an exemplary computing device which may implement the embodiments described herein. The computing device of FIG. 4 may be used to perform embodiments of the functionality for adaptive read ahead in accordance with some embodiments. The computing device includes a central processing unit (CPU) 401, which is coupled through a bus 405 to a memory 403, and mass storage device 407. Mass storage device 407 represents a persistent data storage device such as a floppy disc drive or a fixed disc drive, which may be local or remote in some embodiments. The mass storage device 407 could implement a backup storage, in some embodiments. Memory 403 may include read only memory, random access memory, etc. Applications resident on the computing device may be stored on or accessed via a computer readable medium such as memory 403 or mass storage device 407 in some embodiments. Applications may also be in the form of modulated electronic signals modulated accessed via a network modem or other network interface of the computing device. It should be appreciated that CPU 401 may be embodied in a general-purpose processor, a special purpose processor, or a specially programmed logic device in some embodiments.

Display 411 is in communication with CPU 401, memory 403, and mass storage device 407, through bus 405. Display 411 is configured to display any visualization tools or reports associated with the system described herein. Input/output device 409 is coupled to bus 405 in order to communicate information in command selections to CPU 401. It should be appreciated that data to and from external devices may be communicated through the input/output device 409. CPU 401 can be defined to execute the functionality described herein to enable the functionality described with reference to FIGS. 1-3. The code embodying this functionality may be stored within memory 403 or mass storage device 407 for execution by a processor such as CPU 401 in some embodiments. The operating system on the computing device may be MS DOS™, MS-WINDOWS™, OS/2™, UNIX™, LINUX™, or other known operating systems. It should be appreciated that the embodiments described herein may also be integrated with a virtualized computing system implemented by physical computing resources.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” perform a task or tasks. In such contexts, the phrase “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A processor-based method for adaptive read ahead, comprising:
satisfying a read request with sequential reads from a page cache in a first memory and read ahead from a storage memory to the page cache in the first memory; and
adjusting upward an amount of data to be read by a cycle of the read ahead, responsive to a determination that a desired page of data for the read request is not in the page cache.

2. The method of claim 1, further comprising:
keeping the amount of data to be read by a next cycle of the read ahead same as the amount of data read by a previous cycle of the read ahead, responsive to a determination that the desired page of data for the read request is complete in the page cache.

3. The method of claim 1, further comprising:
triggering a cycle of the read ahead, responsive to a determination that the desired page of data for the read request is not in the page cache and is not being brought into the page cache.

4. The method of claim 1, further comprising:
setting or decreasing an upper limit on the amount of data to be read by cycles of the read ahead, responsive to a low memory condition in the first memory.

5. The method of claim 1, further comprising:
determining that an I/O (input/output) operation is in progress from the storage memory to the first memory; and
determining that the read request is at present being serviced by the first memory, wherein the desired page of data is being read out of the page cache of the first memory, and the determination that the desired page of data is not in the page cache in the first memory is based on the determining that the I/O operation is in progress from the storage memory to the first memory.

6. The method of claim 1, wherein the determination and the adjusting upward act as a feedback mechanism that improves read performance in a storage system.

7. The method of claim 1, further comprising:
increasing the amount of data to be read in cycles of the read ahead, until finding a further desired page complete in the page cache in the first memory prior to or during one of the sequential reads associated with the further desired page, as a result of one of the cycles of the read ahead; and
keeping same the amount of data to be read in at least one further cycle of the read ahead, responsive to the finding.

8. A tangible, non-transitory, computer-readable media having instructions thereupon which, when executed by a processor, cause the processor to perform a method comprising:
performing read ahead cycles, with an amount of data read from a storage memory to a page cache in a first memory in each of the read ahead cycles, to satisfy a read request having sequential reads from the page cache;
determining a status of a desired page of data for the read request; and
increasing the amount of data to be read in at least one subsequent read ahead cycle, as a result of determining the desired page is not in the page cache at a time of servicing a sequential read of the desired page.

9. The computer-readable media of claim 8, wherein the method further comprises:
keeping constant the amount of data to be read in a next read ahead cycle, responsive to determining the desired page of data for the read request is in entirety in the page cache at the time of servicing the sequential read of the desired page.

10. The computer-readable media of claim 8, wherein a next read ahead cycle is triggered by a determination that the desired page of data is neither in the page cache nor in transit from the first memory to the page cache at the time of servicing the sequential read of the desired page.

11. The computer-readable media of claim 8, wherein the method further comprises:
determining whether there is a low memory condition in the first memory; and
decreasing or setting an upper limit on the amount of data to be read in read ahead cycles, in response to determining that there is a low memory condition.

12. The computer-readable media of claim 8, wherein the method further comprises:
further increasing the amount of data to be read in read ahead cycles, in an iterative manner; and
stopping the increasing the amount of data to be read and read ahead cycles, as a result of determining a further desired page is complete in the page cache at a time of servicing a sequential read of the further desired page.

13. The computer-readable media of claim 8, wherein the determining the desired page is not in the page cache and the increasing the amount of data to be read in at least one subsequent read ahead cycle act as a feedback mechanism that decreases read latency in a storage system.

14. An adaptive read ahead system, comprising:
at least one processor;
an adaptive read ahead module in cooperation with the at least one processor;
the adaptive read ahead module having a data read ahead adjuster and a read ahead director;
the read ahead director configured to perform read ahead cycles, each read ahead cycle reading an amount of data from a storage memory to a page cache in a first memory, responsive to a read request having sequential reads from the page cache;
the data read ahead adjuster configured to determine whether a desired page for the read request is in the page cache; and
the data read ahead adjuster configured to increase the amount of data for one or more read ahead cycles, responsive to determining the desired page is not in the page cache.

15. The adaptive read ahead system of claim 14, further comprising:
the data read ahead adjuster configured to set a constant value as the amount of data to be read in read ahead cycles, responsive to determining the entirety of the desired page is in the page cache at the time the sequential read is reading the desired page from the page cache.

16. The adaptive read ahead system of claim 14, further comprising:
the data read ahead adjuster and the read ahead director configured to trigger a read ahead cycle, responsive to determining the desired page is not in the page cache and is not yet being read from the storage memory to the page cache.

17. The adaptive read ahead system of claim 14, further comprising:
the data read ahead adjuster configured to decrease or set an upper limit on the amount of data to be read in read ahead cycles, responsive to a low memory condition in the first memory.

18. The adaptive read ahead system of claim 14, further comprising:
the data read ahead adjuster configured to iterate increases of the amount of data to be read in read ahead cycles; and
the data read ahead adjuster configured to stop the iterating the increases of the amount of data to be read in read ahead cycles, responsive to determining an entirety of the desired page is in the page cache at the time the sequential read is reading the desired page from the page cache.

19. The adaptive read ahead system of claim 14, wherein the data read ahead adjuster and the read ahead director in cooperation decrease latency of the sequential reads from the page cache in comparison to a read ahead with constant amount of data for each read ahead cycle.

20. The adaptive read ahead system of claim 14, wherein the data read ahead adjuster determines whether the data read ahead director is bringing data into the page cache in sufficient time to avoid the read request having to wait.
